(19) United States
(12) Patent Application Publication
(10) Pub. No.: US 2013/0027406 A1
(43) Pub. Date: Jan. 31, 2013

(54) System And Method For Improved Font Substitution With Character Variant Replacement

(71) Applicants: Su Liu, Round Rock, TX (US); Shunguo Yan, Austin, TX (US); Daniel P. McNichol, Cedar Park, TX (US)

(72) Inventors: Su Liu, Round Rock, TX (US); Shunguo Yan, Austin, TX (US); Daniel P. McNichol, Cedar Park, TX (US)

(73) Assignee: International Business Machines Corporation, Armonk, NY (US)

(21) Appl. No.: 13/193,826

(22) Filed: Jul. 29, 2011

(51) Int. Cl. G06T 11/00

(52) U.S. Cl. 345/467; 382/218

(57) ABSTRACT

Text is presented at a computer system in a font that lacks a visual representation for a character by substituting the visual representation of a variant of the character in the text. For example, a character having a Unicode code point is associated with variants in a character variant table, each variant having a code point different from the character. In one embodiment, if text calls for presentation of the character in a font not supported by a computer system, a variant is selected that supports the font and a graphical representation of the variant is substituted for the character.

### BACKGROUND OF THE INVENTION

1. Field of the Invention

The present invention relates in general to the field of presenting text as characters, and more particularly to a system and method for improved font substitution with character variant replacement.

2. Description of the Related Art

Computer systems present textual information to end users with a font, which is an electronic data file containing a set of glyphs. Each glyph is a visual representation of a character of a font where the visual representations of a font have a common style of typeface. As the number of characters defined in a font increases, a greater number of glyphs are needed to present the characters of the font. For example, a basic font to support the English language has a glyph for each capital and small letter of the alphabet. A more complex font will include a glyph for each desired punctuation or other symbol of interest to an end user.

The availability of glyphs for characters defined in a code set of one or more fonts directly impacts if text can be properly presented to an end user with a visual representation. The more characters available in a code set at a computer system, the more glyphs are needed by the computer system to present the characters. Unicode is a standardized super code set, now at its sixth version, which provides fonts for hundreds of languages and includes over 100,000 graphic symbols. The number of characters included in Unicode continues to increase as new characters are continuously defined in different languages, especially eastern Asian languages such as Chinese, Japanese and Korean. As characters are added to Unicode, font vendors update fonts to add new glyphs and end users purchase updated fonts in order to present characters at their computer systems.

One difficulty that arises with the growth of Unicode is that different users with different versions of fonts cannot share text for presentation if a file created in a first computer system includes a character of a font that a second computer system lacks a glyph to present. In a distributed file sharing system, a lack of font support at a network node may mean that file names and content cannot be properly displayed due to missing glyphs at the second computer system. In some instances, end users, file system management tools and network monitoring tools will be unable to access or monitor files and network nodes due to missing characters. In some instances, applications such as web browsers and word editors will be unable to display characters, instead presenting an empty box where a glyph is unavailable. The problem is particularly difficult for languages like Chinese where creating glyphs is expensive.

U.S. Patent Publication Number 2008/0079730 by Zhang provides one solution to address an unavailability of a glyph in a font through font substitution. Font substitution attempts to replace a character for a font that either is not available or does not contain a glyph with a glyph of another font that has the character. For example, Zhang has a character level font linker that uses the Unicode code point of a character unavailable in a first font to retrieve a glyph for the character from a different font. A difficulty with font substitution is that, if no glyph has been defined for a newly created character, no substitution is available and the character cannot be displayed.

### SUMMARY OF THE INVENTION

Therefore, a need has arisen for a system and method which provides a visual representation of an unavailable character.

In accordance with the present invention, a system and method are provided which substantially reduce the disadvantages and problems associated with previous methods and systems for substituting a character for presentation at a computer system. A glyph of a variant of a character for display as text is used to substitute the character where the character lacks a glyph.

More specifically, a computer system identifies a character in text for presentation at a display based upon the lack of a graphical representation for the character at the computer system, such as where a character is not supported by a font due to a lack of a glyph in the font for the character. A variant character substitution module identifies variants of the character and glyphs available for the identified variants, and then substitutes a selected of the variant glyphs for the character. The computer system presents the character at the display with the variant glyph as a graphical representation of the character. The textual string that included the variant remains unchanged so that the computer system continues to maintain the underlying content of the text while presenting the variant for viewing at a display for an end user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a computer system configured to present a character variant as a substitute for a character that is not supported by a font;

FIG. 2 depicts a flow diagram of a process for maintaining a character variant table to support substitution of characters for display as text at a computer system; and

FIG. 3 depicts a flow diagram of a process for substituting a character with a variant for presentation of text at a computer system.

### DETAILED DESCRIPTION

A system and method provides for presentation of a character at a computer system display when the character is not supported by a font at the computer system. A character variant table associates character variants with a character so that a graphical representation of a selected of the character variants substitutes for the unsupported character. A glyph of an available variant of a character substitutes for a character in a text string when the character in the text string is missing a glyph or font in a user computer system. Management of character substitution with a variant glyph is provided by rules that govern the selection of a variant glyph for substitution of a character in a text string when plural variant glyphs are available. Presentation of the variant glyph as a substitution for a character in a textual string does not change the underlying textual string character values so that the computer system continues to use the underlying values, such as to track a file name. Thus, a user can view characters at a computer system even if the character does not have any glyphs defined in any fonts supported by the computer system. Code point information for the character is applied to identify a variant of the character having a different code point that is supported at the computer system. Presenting the variant of the character with a different code point provides an end user with a visual representation that allows recognition of the text while allowing the computer system to track the actual character code point value. Networked nodes of a distributed system are thus able to present file names and file content where separate nodes have different supported fonts. Because variant characters in some languages have similar appearances, the presentation of variant characters will often provide a better visual representation at a computer system than will a presentation of the same character using font substitution.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

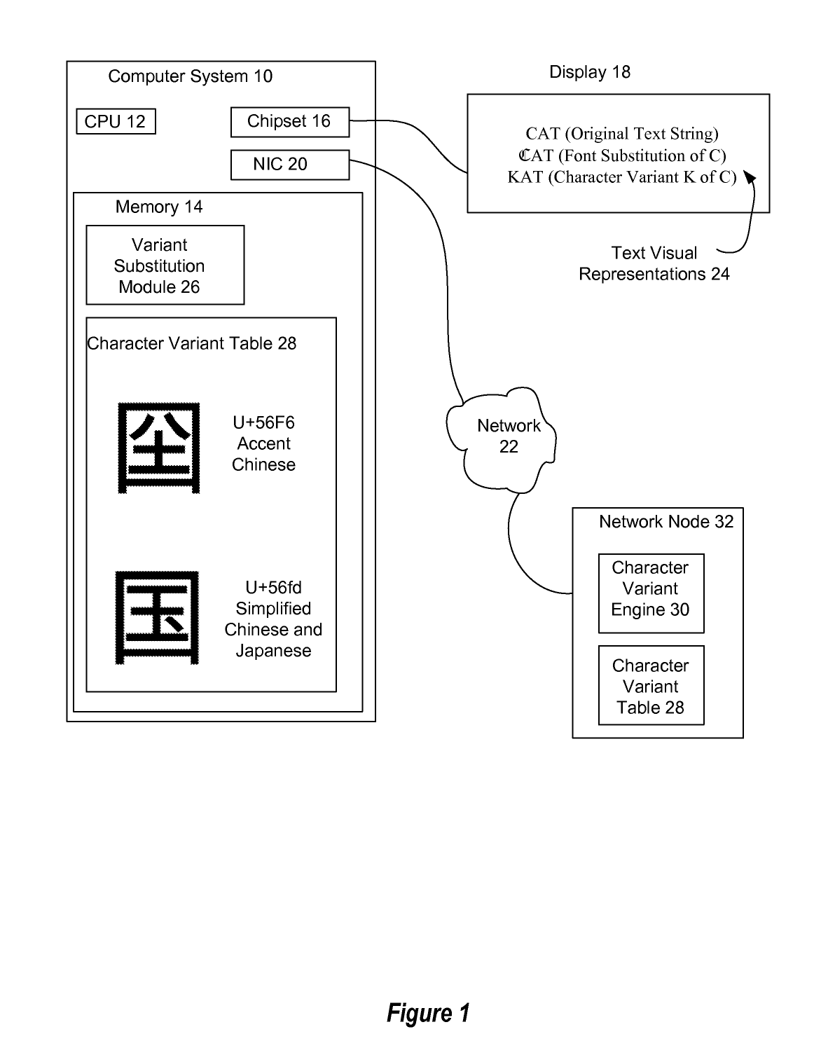

Referring now to FIG. 1, a block diagram depicts a computer system 10 configured to present a character variant as a substitute for a character that is not supported by a font. Computer system 10 executes instructions with a processor 12 and memory 14, which stores instructions for execution by processor 12. A chipset 16 interfaces with processor 12 to coordinate communication with Input/Output devices, such as a display 18, which presents information as graphical representations. Chipset 16 also coordinates communication between processor 12 and a network 22 through a network interface card 20.

An application executing on processor 12 generates a text string 24 for presentation at display 18. For example, the text string is a file name of information stored at a network node, a word in a word processer, or a word in web browser. The text string consists of a Unicode code point for each character. Graphical processing in chipset 16 presents a graphical representation of each character at display 18 based upon the font in use at computer system 10. The font is a set of glyphs with a glyph assigned to each code point defined by the font. In the example embodiment depicted by FIG. 1, the text string “CAT” is depicted by selecting the glyph defined by the Times New Roman font for each of the Unicode code points U+0043 (the letter “C”), U+0041 (the letter “A”) and U+0054 (the letter “T”). If the Times New Roman font lacks a glyph for the letter “C”, then conventional font substitution would look for another font at computer system 10 that does include a glyph for the code point U+0043 (the letter “C”), such as the font [symbol] [symbol] [symbol] ( [symbol] ). Although the letter “C” appears different in the Old English Text, the Unicode code point value is the same for both depictions under conventional font substitution.

Rather than substitute a character glyph of a first font with a character glyph of a second font, a variant substitute module 26 executing on processor 12 identifies a variant of a character from a character variant table 28 and uses the code point of the variant to generate a graphical representation of text 24. As an explanatory example using the English alphabet, consider that computer system 10 lacks a glyph to present a graphical representation of the letter “C” associated with Unicode code point U+0043 in the Times New Roman font. Rather than substituting with the glyph for code point U+0043 in the Old English Text font, variant substitute module 26 retrieves the letter “K” as a variant of the letter “C” and uses the Unicode code point U+004B to retrieve a glyph in the Times New Roman font for presenting the letter “K”. Thus, the text string “CAT” is displayed “KAT” by using a character variant substitution rather than as “ [symbol] AT” using a font substitution. Computer system 10 maintains the Unicode code point values so that the actual text is tracked for use by computer system 10, such as to retrieve a file name “CAT”.

Character variant substitution provides a valuable tool in eastern Asian languages, such as Chinese, where characters often have variants that are very close in meaning. For example, Chinese characters often have two well known written variants, Simplified and Traditional, which are written differently and thus have different appearances, but are pronounced and mean the essentially the same thing. Another type of variant is a resemblance variant. One analysis of 3500 commonly used Simplified Chinese characters in the Unihan database, a Chinese, Japanese and Korean character database in Unicode, found that 2191 characters have one or more variants. One example of variants depicted in FIG. 1 are the characters U+56F6 in Accent Chinese and U+56fd in Simplified Chinese. Thus, for example, if a text string calls for presentation of U+56F6 in a first font that lacked a glyph for the character, then variant substitute module 26 would identify U+56fd as a variant of U+56F6 and would present the glyph of U+56fd in the first font as a substitute for U+56F6. If U+56fd does not have a glyph in the first font, as an alternative, variant substitute module 26 can present a glyph of variant character U+56fd in a different font.

Character variants are identified by a character variant engine 30, such as instructions running on a network node 32 to update a character variant table 28 as characters are added to Unicode. In one embodiment, character variant engine 30 associates newly-added characters with character variants to update character variant table 28 by manual inputs made by language experts familiar with the relevant language and its symbols. Alternatively, character variant engine 30 automates the character-variant association of a newly-added character with existing characters through a graphical analysis of the properties of the newly-added character compared with the properties of existing characters. For example, a relationship between simplified versus traditional Chinese characters is identified with a mathematical analysis that compares graphical similarity of the characters as represented by an image bitmap or other graphical representation. Once character variant relationships are established, character variant engine 30 updates character variant table 28 and the updates are deployed through network communications, such as with software updates to applications through regular maintenance.

In operation, when processor 12 generates a text string for presentation at display 18 that has a character lacking a glyph in the font used to present a text visual representation 24, then a request is made to variant substitute module 26 to determine a substitute for the character lacking the glyph. Variant substitute module 26 retrieves all variants of the character from character variant table 28 and identifies the variants that have glyphs available for presentation as a graphical representation. Variant substitute module 26 applies rules to select a variant for use as a substitute of the character and then selects a glyph of the variant for use as a substitute at display 18. The selected glyph of the selected variant then replaces the character in text visual representation 24. The glyph substitution rules are user-defined policies to perform a selection where more than one glyph is available to use as a variant character substitution. Substitution rules are applied automatically at computer system 10 based on local settings or network settings retrieved from network node 32. For example, a user may define use of a resemblance variable first and use of a written variant only if a resemblance variant does not exist. Similar rules may apply to make a traditional or simplified character a priority to substitute. In one embodiment, the rules are applied in the building of character variant table 28 so that the first-found variant is used as a substitute.

In one embodiment, a client-server implementation stores a character variant table 28 at a network node 32. Font substitution logic and default rules are created, updated and deployed in a centralized server so that all clients of the network can download the character variant table 28 and apply the logic and rules locally as needed. In one alternative embodiment, the substitution logic includes a configuration option for clients to customize the substitution rules as needed.

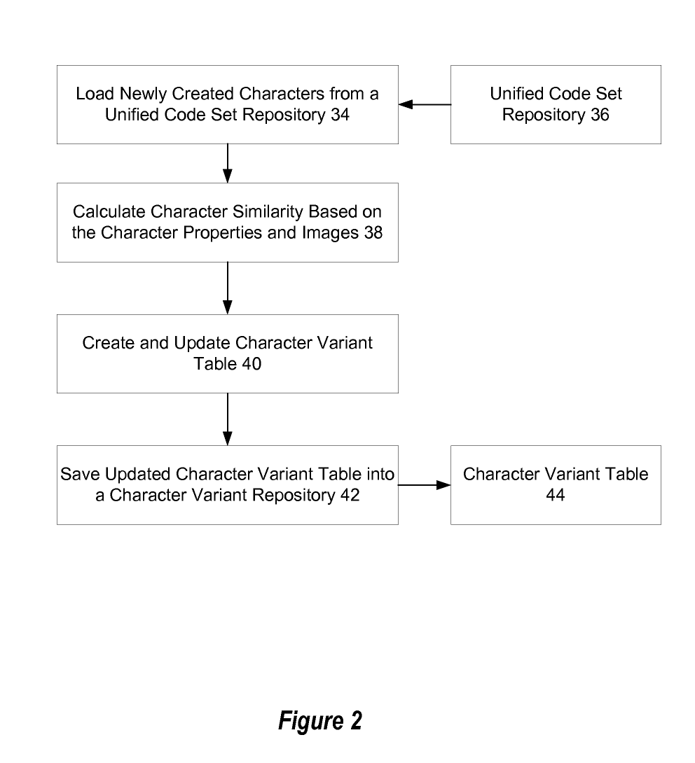

Referring now to FIG. 2, a flow diagram depicts a process for maintaining a character variant table to support substitution of characters for display as text at a computer system. The process begins at step 34 with loading of newly created characters from a unified code set repository 36. Characters that are added to the code set are selected for analysis as new characters are detected. At step 38, a calculation is performed for graphic similarities between the newly created characters and existing characters. The analysis can include manual association of characters as variants of each other by a language expert, and can include an automated analysis to detect similarities between properties and images, such as by a comparison of bitmaps for presentation of the characters. At step 40, identified variants are updated in the character variant table. At step 42, the updated character variant table is saved to a repository 44 for deployment to computer systems, such as through the Internet.

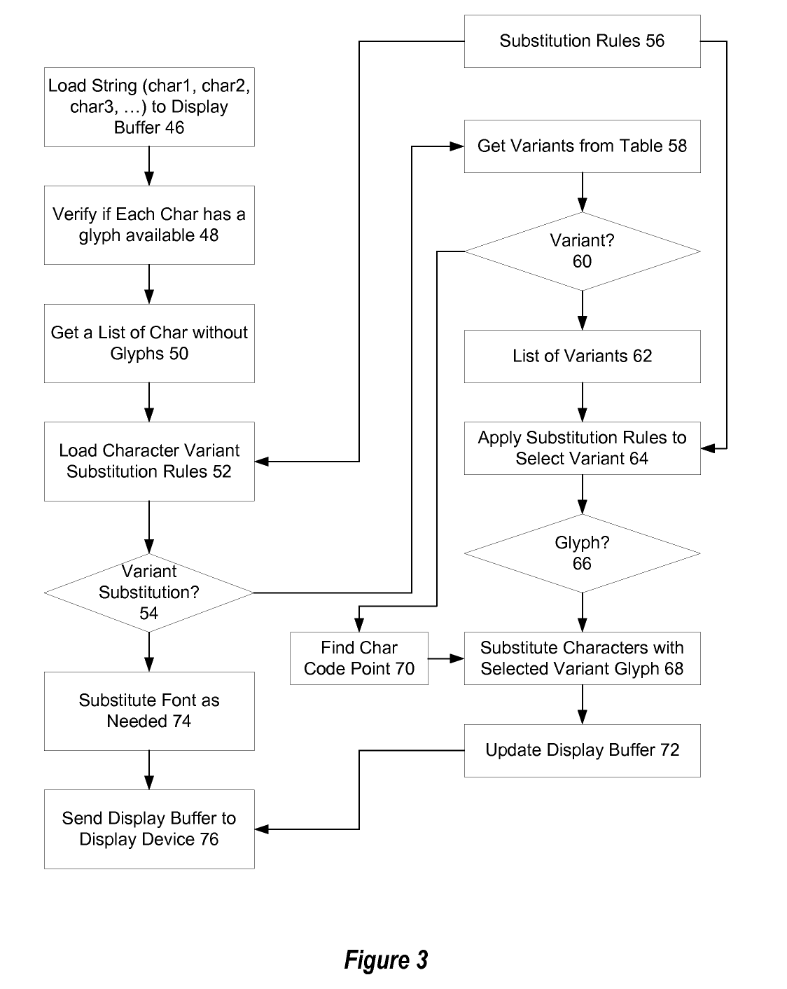

Referring now to FIG. 3, a flow diagram depicts a process for substituting a character with a variant for presentation of text at a computer system. The process begins at step 46 with loading of a text string (char1, char2, char3, . . . ) into an output buffer in preparation for presentation as visual representations of text at display. At step 48, the text string is traversed to verify that each character in the text string has a glyph to support a visual representation of the character in the desired font. At step 50, a list is generated of characters in the text string which lack a glyph in the current font. At step 52, user-defined rules are loaded from substitution rules 56 that define glyph substitution rules, substitution levels and character variant definitions for the characters that have multiple variants. Substitutions are based upon a character variant table that considers factors such as operating system, font server, client, application or user parameters.

At step 54, a determination is made of whether substitution with a character variant should take place for the missing glyphs based upon the substitution rules. If substitution with a character variant is determined, the process continues to step 58 to get character variants associated with the character that lacks a glyph from the character variant table. At step 60, a determination is made of whether character variants exist for the character so that glyphs of the character variants may be used to substitute for the character. If no variants exist at step 60, the process proceeds to step 70 to locate the code point for the original character so that code point information may be presented to the end user. If at step 60 a variant does exist, the process continues to step 62 to get a list of character variants that have glyphs available for use as a substitution. At step 64, substitution rules are applied to select a preferred of plural glyphs for use in the substitution. At step 66, a determination is made of whether a glyph is available for substitution. If not, the process continues to step 70 to get the character code point for presentation to the user. If a glyph is selected to substitute for the character, the process continues to step 68 to perform the substitution and step 72 to update the display buffer with the new code point for presentation. If at step 54 a determination is made that no variants exist with glyphs for substitution, the process continues to step 74 to determine if a font substitution is supported. From steps 72 and 74, the update display buffer is forwarded to the display device for presentation as a graphical representation of the text string.

Although the present invention has been described in detail, it should be understood that various changes, substitutions and alterations can be made hereto without departing from the spirit and scope of the invention as defined by the appended claims.

1. A method for substituting a character at a computer system display, the method comprising:
identifying a character that lacks a glyph;
retrieving one or more variants of the character from a memory;
selecting a variant glyph of the one or more variants;
presenting the selected variant glyph as the character; and
maintaining a text string of the character in association with the variant glyph, the text string for providing character for non-presentation functions.

1. The method of claim 1 wherein the character represents a meaning in a first language and the variant glyph represents a meaning in a second language.

2. The method of claim 1 wherein the character and the variants have a common font.

3. The method of claim 1 wherein the character and variants have different Unicode code point values.

4. The method of claim 1 wherein the character comprises a Chinese character and the variant comprises a traditional variant of the Chinese character.

5. The method of claim 1 wherein the character comprises a Chinese character and the variant comprises a simplified variant of the Chinese character.

6. The method of claim 1 wherein retrieving one or more variants of the character from memory further comprises accessing a character variant table through a network interface, the character variant table defining character variants.

7. The method of claim 1 wherein selecting a variant glyph comprises automatically applying rules to order variants of the character in priority to substitute the glyph.

8. The method of claim 1 further comprising analyzing plural characters to define variants based upon graphical similarity between the plural characters, including a comparison of bitmaps for presentation of the plural characters.

9. A computer system for presenting text as visual representations, the computer system comprising:
a processor operable to execute instructions;
a display operable to present text as visual representations; and
memory interfaced with the processor, the memory storing instructions for the processor to execute, the instructions:
identifying a text having a character value without an associated glyph;
selecting a variant of the character value, the variant having an associated variant glyph;
presenting the variant glyph as a visual representation of the character value at the display; and
maintaining the character value in the memory in association with the variant glyph.

11. The computer system of claim 10 wherein the character comprises a first Unicode code point and the variant of the character comprises a second Unicode code point different from the first Unicode code point.

12. The computer system of claim 11 wherein the character and variant have a common font.

13. The computer system of claim 11 wherein the character and variant have different fonts.

14. The computer system of claim 10 wherein the character comprises a Chinese character and the variant comprises a traditional variant of the Chinese character.

15. The computer system of claim 10 wherein the character comprises a Chinese character and the variant comprises a simplified variant of the Chinese character.

16. The computer system of claim 10 further comprising a network interface operable to interface with a network and a character variant table stored at a network location provide variants of a character in response to a query from the processor.

17. A method for presenting text with a visual representation at a display, the method comprising:
associating a character with plural variants;
determining that the text includes the character in a font that lacks information for generation of a visual representation of the character at the display;
determining that one or more of the plural variants has a visual representation; and
using the visual representation of a selected of the plural variants for presentation at the display in the text as a substitute for the character while maintaining the character as the value associated with the visual representation.

18. The method of claim 17 wherein the character has a Unicode code point and one or more variants have Unicode code points different from the character.

19. The method of claim 17 wherein the visual representation of the selected of the plural variants has the same font as the text.

20. The method of claim 17 wherein the visual representation of the selected of the plural variants has a different font than the text.
